(19) United States
(12) Patent Application Publication
(10) Pub. No.: US 2012/0008970 A1
(43) Pub. Date: Jan. 12, 2012

(54) IMAGE FORMING APPARATUS AND CLEANING METHOD

(75) Inventor: Sunao Takenaka, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/177,687

(22) Filed: Jul. 7, 2011

Related U.S. Application Data
(60) Provisional application No. 61/362,437, filed on Jul. 8, 2010.

(51) Int. Cl. G03G 15/16

(52) U.S. Cl. 399/66

(57) ABSTRACT

An image forming apparatus comprising: a first image bearing member; a second image bearing member on which a toner having at least a particle diameter or a circularity different from that of the toner supplied to the first image bearing member is supplied, coming into contact with, further upstream than a contact position between the first image bearing member and a recording medium or a transfer member; a first transfer member; a second transfer member; a printing-information acquiring section which acquires single color printing information; a printing determining section which determines, whether the executed printing in the single color exceeds a reference; a toner-image forming section which forms the toner image on the second image bearing member if the printing in the single color exceeds the reference; and a transfer-bias applying section which applies the bias to the first transfer member and the second transfer member, transfer the toner image formed on the second image bearing member, and move the toner from the toner image on the recording medium or the transfer member onto the first image bearing member.

### CROSS-REFERENCE TO RELATED APPLICATION

This application is based upon and claims the benefit of priority from U.S. provisional application 61/362,437, filed on Jul. 8, 2010; the entire contents of which are incorporated herein by reference.

### FILED

Embodiments described herein relate generally to a technique concerning an image forming apparatus of an electrophotographic system.

### BACKGROUND

In recent years, chemically manufactured toners such as a polymerized toner are extensively developed. A reduction in particle diameters and spheronization of toners are in progress. The reduction in particle diameter and the spheronization are advantageous for improvement of image quality. On the other hand, since rolling resistance of the toners decreases, cleaning of a residual toner by a cleaning blade is difficult in a photoconductive drum.

Therefore, there is proposed a technique for mixing toners having different particle diameters and different spherical shapes and improving cleaning performance. On the other hand, there is also a request for maintenance of image quality improved by the reduction in particle diameters and the spheronization.

Therefore, there is proposed a technique for supplying auxiliary particles having a particle diameter and a circularity different from those of a toner for toner image formation to a photoconductive drum. However, it is necessary to provide a unit for supplying the auxiliary particles in an apparatus anew. This prevents a reduction in size of the apparatus and could cause an increase in cost.

### DESCRIPTION OF THE DRAWINGS

FIG. 1 is a schematic diagram of an image forming apparatus according to a first embodiment;

FIG. 2 is a schematic diagram of an image forming unit included in the image forming apparatus according to the first embodiment;

FIG. 3 is a graph for explaining a relation between a circularity and linear pressure for enabling a cleaning blade to perform cleaning;

FIG. 4 is a functional block diagram concerning reverse transfer execution control for a toner during execution of a single color (K) mode in the image forming apparatus according to the first embodiment;

FIG. 5 is a diagram of an example of a cleaning toner image in the image forming apparatus according to the first embodiment;

FIG. 6 is a diagram of an example of a timing chart concerning the reverse transfer execution control for a toner during the execution of the single color (K) mode in the image forming apparatus according to the first embodiment;

FIG. 7 is a flowchart for explaining an example of a processing flow concerning the reverse transfer execution control for a toner during the execution of the single color (K) mode in the image forming apparatus according to the first embodiment;

FIG. 8 is a schematic diagram of a switching mechanism of an image forming apparatus according to a second embodiment;

FIG. 9 is a schematic diagram of the switching mechanism of the image forming apparatus according to the second embodiment;

FIG. 10 is a functional block diagram concerning reverse transfer execution control for a toner during execution of a single color (K) mode in the image forming apparatus according to the second embodiment;

FIG. 11 is a diagram of an example of a timing chart concerning the reverse transfer execution control for a toner during the execution of the single color (K) mode in the image forming apparatus according to the second embodiment;

FIG. 12 is a flowchart for explaining an example of a processing flow concerning the reverse transfer execution control for a toner during the execution of the single color (K) mode in the image forming apparatus according to the second embodiment;

FIG. 13 is a diagram of an example of a cleaning toner image in an image forming apparatus according to a third embodiment; and

FIG. 14 is a diagram of an example of a timing chart concerning reverse transfer execution control for a toner in the image forming apparatus according to the third embodiment.

### DETAILED DESCRIPTION

In general, according to one embodiment, an image forming apparatus includes: a first image bearing member on which a toner is supplied to a formed electrostatic latent image and a toner image is formed; a cleaning member configured to come into contact with the first image bearing member and remove the toner remaining on the first image bearing member after the toner image is transferred; a second image bearing member on which a toner having at least a particle diameter or a circularity different from that of the toner supplied to the first image bearing member is supplied to a formed electrostatic latent image and a toner image is formed, the second image bearing member coming into contact with, further upstream than a contact position between the first image bearing member and a conveyed recording medium or a transfer member configured to transfer the toner image onto the recording medium, the recording medium or the transfer member; a first transfer member configured to be applied with bias and transfer the toner image formed on the first image bearing member onto the recording medium or the transfer member; a second transfer member configured to be applied with bias and transfer the toner image formed on the second image bearing member onto the recording medium or the transfer member; a printing-information acquiring section configured to acquire, if printing in a single color using the first image bearing member is executed, single color printing information, which is information concerning the printing in the single color; a printing determining section configured to determine, using the single color printing information acquired by the printing-information acquiring section, whether the executed printing in the single color exceeds a reference; a toner-image forming section configured to form the toner image on the second image bearing member if the printing determining section determines that the executed printing in the single color exceeds the reference; and a transfer-bias applying section configured to apply the bias to the first transfer member and the second transfer member, transfer the toner image formed on the second image bearing member by the toner-image forming section onto the recording medium or the transfer member, and move the toner from the toner image on the recording medium or the transfer member onto the first image bearing member.

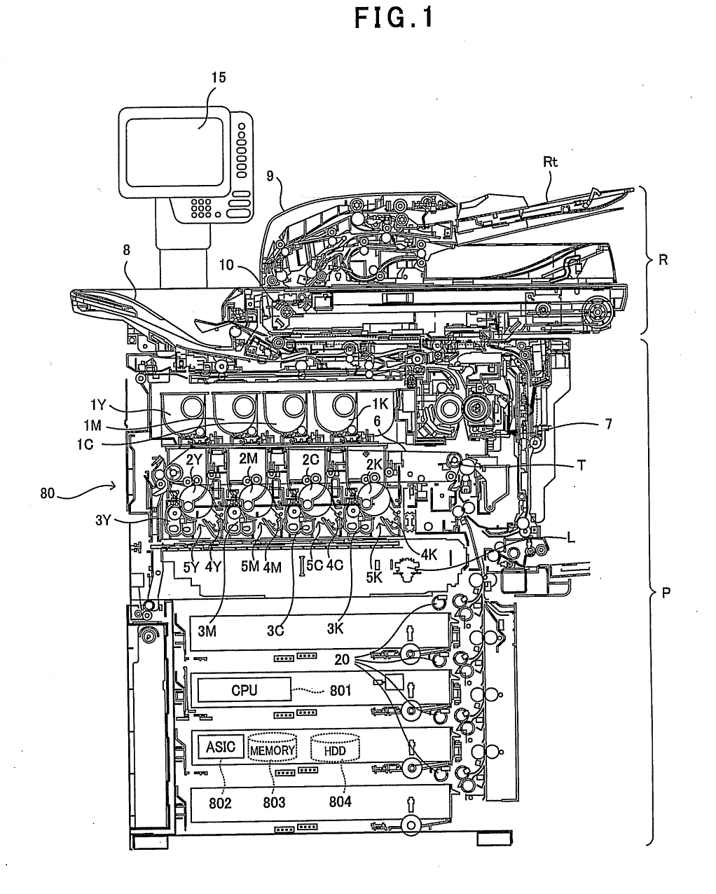

FIG. 1 is a longitudinal sectional view of a schematic configuration of a multi function peripheral (MFP), which is an example of an image forming apparatus according to a first embodiment.

As shown in FIG. 1, the image forming apparatus according to the first embodiment includes an image reading section R and an image forming section P.

The image reading section R has a function of scanning and reading images of a sheet document and a book document.

The image forming section P has a function of forming a toner image on a sheet on the basis of an image read from an original document by the image reading section R, image data transmitted from an external apparatus to the MFP, or the like.

The image reading section R includes an auto document feeder (ADF) 9 configured to be capable of automatically feeding an original document to a predetermined image reading position. The image reading section R reads, with a scanning optical system 10, an image of an original document automatically fed by the auto document feeder 9 and placed on a document tray (a predetermined document placing table) Rt or an original document placed on a not-shown document table.

The image forming section P includes a pickup roller 20, an image forming unit 80, a fixing device 7, a discharge tray 8, toner cartridges 1Y to 1K (developer cartridges), and a laser unit L. The image forming unit 80 includes process units 5Y to 5K (Y to K stations) for yellow (Y), magenta (M), cyan (C), and black (K) and an intermediate transfer belt 6. The process unit 5Y includes a photoconductive drum 2Y, a developing unit 3Y, and a charger 4Y. Similarly, the process units 5M to 5K include photoconductive drums 2M to 2K, developing units 3M to 3K, and chargers 4M to 4K.

The MFP according to the first embodiment includes a CPU 801, an ASIC (Application Specific Integrated Circuit) 802, a memory 803, and a HDD (Hard Disk Drive) 804 (see FIG. 1). The CPU 801 has a role of performing various kinds of processing in the MFP and also has a role of executing a computer program temporarily stored in the memory 803 to thereby realize various functions. The CPU 801 can be substituted by an MPU (Micro Processing Unit) configured to be capable of executing equivalent arithmetic processing. Similarly, the HDD 804 can be substituted by a storage device such as a flash memory.

The ASIC 802 is mounted with hardware (a circuit) configured to control the various functions of the MFP.

The memory 803 can include, for example, a RAM (Random Access Memory), a ROM (Read Only Memory), a DRAM (Dynamic Random Access Memory), an SRAM (Static Random Access Memory), or a VRAM (Video RAM). The memory 803 has a role of temporarily storing various kinds of information and computer programs used in the MFP, log information of executed processing, or the like.

The MFP according to the first embodiment includes an operation section 15 with which a user can input requests concerning various kinds of processing for the MFP. The operation section 15 includes a power switch for switching an energization state (ON/OFF) from a not-shown power supply to the MFP, a graphical display mounted with a touch panel sensor, frequently-used processing input buttons such as number buttons, a start button, and a cancel button, and a state display LED.

As an example of processing in the MFP according to the first embodiment, an overview of copy processing is explained.

Images of plural sheet documents continuously automatically fed by the auto document feeder 9 are read by the image sensor 10 such as CCD (Charge Coupled Device) in a predetermined image reading position.

Sheets picked up from a cassette by the pickup roller 20 are supplied into a sheet conveying path. The sheets supplied into the sheet conveying path are conveyed in a predetermined conveying direction by plural roller pairs.

The image forming unit 80 forms toner images on the basis of image data of the images read from the original documents by the image reading section R and transfers the toner images onto the sheets.

The toner images transferred onto the sheets are heated and fixed on the sheets by a heating roller of the fixing device 7.

The sheets having the toner images fixed thereon are conveyed through a conveying path by plural conveying roller pairs and sequentially discharged onto the discharge tray 8.

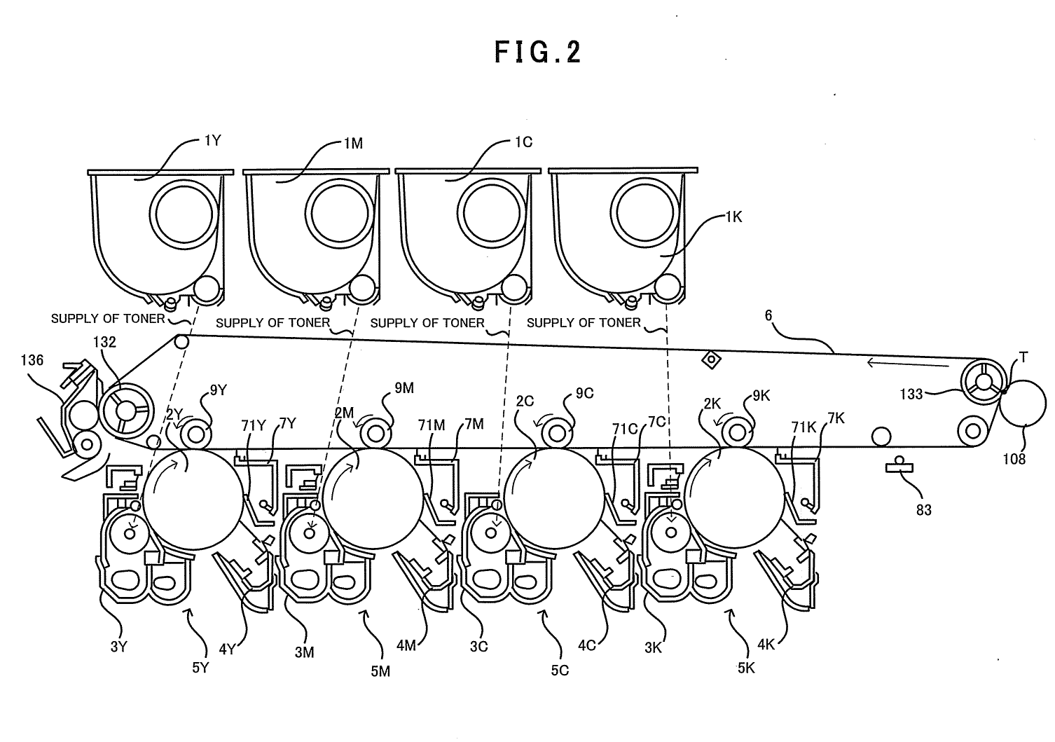

The image forming unit 80 of the image forming apparatus according to the first embodiment is schematically explained with reference to FIG. 2.

The intermediate transfer belt 6 is equivalent to the transfer member.

In the first embodiment, the photoconductive drum 2K is equivalent to the first image bearing member and the photoconductive drum 2Y is equivalent to the second image bearing member. The photoconductive drums 2M and 2C are equivalent to the plural image bearing members configured to come into contact with the transfer member between the first image bearing member and the second image bearing member.

A transfer roller 9K is equivalent to the first transfer member and a transfer roller 9Y is equivalent to the second transfer member. Transfer rollers 9M and 9C are equivalent to the plural transfer members configured to transfer toner images from the plural image bearing members onto the transfer member.

The image forming unit 80 is a tandem image forming unit including process units 5Y to 5K configured to use toners of four colors of yellow (Y), magenta CM), cyan (C), and black (K) and including photoconductive members for the respective colors.

The intermediate transfer belt 6, which is an endless belt, is suspended and stretched around plural rollers and rotated in an arrow direction by a not-shown driving motor.

In FIG. 2, first, in the process unit 5Y for yellow, the charger 4Y, the developing unit 3Y, and a cleaner 7Y are arranged around the photoconductive drum 2Y having an organic photoconductive member (OPC) on the surface and configured to rotate in an arrow direction. Similarly, in the process unit 5M for magenta, the process unit 5C for cyan, and the process unit 5K for black, the chargers 4M to 4K, the developing units 3M to 3K, and cleaners 7M to 7K are arranged around the respective photoconductive drums 2M, 2C, and 2K. On the inner side of the intermediate transfer belt 6 in contact with the photoconductive drums 2Y, 2M, 2C, and 2K for the four colors in transfer positions (primary transfer positions and nip positions between the photoconductive drums 2Y to 2K and the intermediate transfer belt 6), the primary transfer rollers 9Y, 9M, 9C, and 9K, to which primary transfer bias is applied for each of the colors during toner image transfer, are provided in contact with the intermediate transfer belt 6 at moderate pressure. The primary transfer rollers 9Y, 9M, 9C, and 9K are driven to rotate following the rotation of the intermediate transfer belt 6.

In the position of a roller 133, a secondary transfer roller 108 is provided in contact with the roller 133 at moderate pressure. The secondary transfer roller 108 is driven to rotate following the rotation of the intermediate transfer belt 6 and configured to form, in conjunction with the roller 133, a position (a secondary transfer position T) where transfer from the intermediate transfer belt 6 onto a conveyed sheet (secondary transfer) is executed.

In the position of a roller 132, a cleaner 136 configured to remove toners remaining on the intermediate transfer belt 6 after the secondary transfer is provided.

When image forming processing is started, first, in order to form toner images of yellow (Y), magenta (M), cyan (C), and black (K), the surfaces (photoconductive surfaces) of the photoconductive drums 2Y, 2M, 2C, and 2K are uniformly charged by corona discharge from the chargers 4Y to 4K.

Exposure corresponding to an image signal is applied to the charged photoconductive surfaces by the laser unit L. As a result, electrostatic latent images are formed on the photoconductive surfaces. Subsequently, toners are supplied from the developing units 3Y, 3M, 3C, and 3K to the photoconductive surfaces of the photoconductive drums 2Y to 2K on which the electrostatic latent images are formed. Consequently, the electrostatic latent images formed on the photoconductive surfaces of the photoconductive drums 2Y to 2K are visualized (formation of toner images). The toners are supplied to the developing units 3Y to 3K from the toner cartridges 1Y to 1K.

The toner images formed on the photoconductive drums 2Y to 2K in this way are transferred onto the belt surface of the intermediate transfer belt 6 in the primary transfer positions by transfer rollers 9K to 9Y to which bias is applied. The toner images carried by the rotation of the intermediate transfer belt 6 are transferred onto a conveyed sheet in the secondary transfer position T.

The toners remaining on the photoconductive surfaces of the photoconductive drums 2Y to 2K without being transferred are scraped off and removed by cleaning blades (equivalent to the cleaning member) 71Y to 71K of the cleaners 7Y to 7K that are in contact with the photoconductive surfaces.

For example, if another photoconductive drum is present further downstream than the photoconductive drum 2Y, a part of the toner image transferred from the photoconductive drum 2Y onto the intermediate transfer belt 6 moves onto the other photoconductive drum before reaching the secondary transfer position T (reverse transfer).

In the first embodiment, a toner having a circularity (an average circularity) different from that of toners stored in the toner cartridges 1M to 1K is stored in the toner cartridge 1Y.

Therefore, in the first embodiment, when the toner image transferred from the photoconductive drum 2Y onto the intermediate transfer belt 6 passes the primary transfer positions of the other photoconductive drums 2M to 2K, the toner supplied from the toner cartridge 1Y moves onto the photoconductive drums 2M to 2K according to the reverse transfer. Therefore, in the first embodiment, the toners having the different circularities are mixed on the photoconductive surfaces of the photoconductive drums 2M to 2K. Cleaning performance for the photoconductive drums 2M to 2K is improved.

The circularity of the toner stored in the toner cartridge 1Y and the circularity of the toners stored in the toner cartridges 1M to 1K are not specifically limited. Those skilled in the art can set the circularities as appropriate. For example, the circularity of the toner stored in the toner cartridge 1Y can be set to 0.92 and the circularity of the toners stored in the toner cartridges 1M to 1K can be set to 0.96.

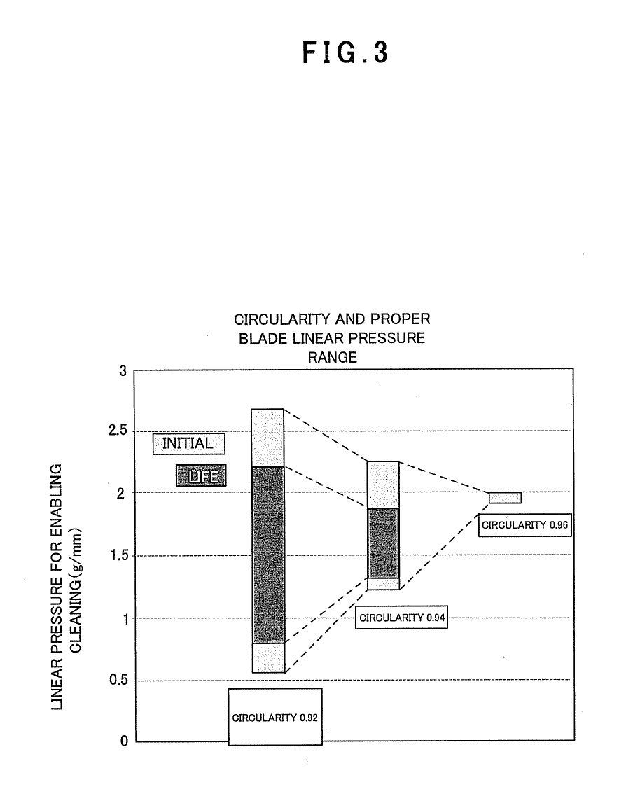

As a reference, a relation between a circularity and a linear pressure for enabling a cleaning blade to perform cleaning is shown in FIG. 3. As it is understood from FIG. 3, it is possible to increase, by setting the circularity of the toner stored in the toner cartridge 1Y to 0.92 and setting the circularity of the toners stored in the toner cartridges 1M to 1K to 0.96, the width of a range of the linear pressure for enabling the cleaning blade to perform cleaning. Therefore, it is possible to cope with various apparatus designs.

It is desirable that the circularity of a toner in a process unit on an upstream side is lower than the circularity of a toner in a process unit on a downstream side.

The circularity is a shape index concerning a projected image of particles and can be calculated on the basis of the following formula.

F=L1/L2

where, F is a circularity, L1 is a circumferential length of a circle having a projection area equal to that of a particle, and L2 is a peripheral length of the particle.

A value of the circularity can be obtained by, for example, measurement performed by using a flow particle image analyzer. Examples of the flow particle image analyzer include FPIA2100 manufactured by Sysmex Corporation.

The image forming apparatus according to the first embodiment has a single color (K) mode in which a black image is formed and a color mode in which an image also including colors other than black is formed. In the single color (K) mode, during image formation on a sheet, a toner image is transferred only from the photoconductive drum 2K onto the intermediate transfer belt 6 and an image is formed. On the other hand, in the color mode, during image formation on a sheet, toner images are transferred from, in addition to the photoconductive drum 2K, the photoconductive drums 2Y, 2M, and 2C onto the intermediate transfer belt 6 and an image is formed.

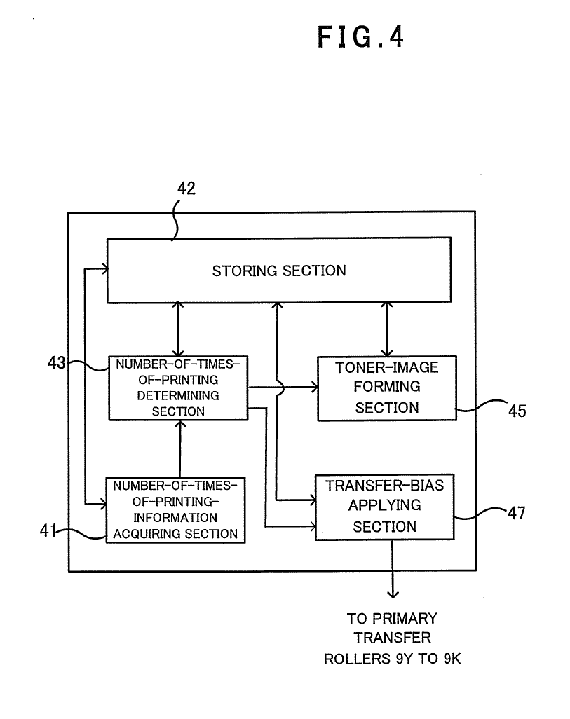

Functional blocks concerning reverse transfer execution control for a toner during execution of the single color (K) mode are explained with reference to FIG. 4.

In this embodiment, a toner image as a supply source of a toner moved (reversely transferred) from the intermediate transfer belt 6 onto a photoconductive drum and improving cleaning performance for the photoconductive drum is referred to as cleaning toner image. In the first embodiment, the cleaning toner image is formed on the photoconductive drum 2Y and transferred onto the intermediate transfer belt 6. Therefore, in the first embodiment, the toner forming the cleaning toner image has a circularity lower than that of the toners supplied from the developing units 3M to 3K to the photoconductive drums 2M to 2K during toner image formation.

The cleaning toner image formed on the photoconductive drum 2Y in the first embodiment can also be used in combination with, for example, an image density adjustment pattern.

The image forming apparatus according to the first embodiment includes a storing section 42, a number-of-times-of-printing-information acquiring section 41 (equivalent to the printing-information acquiring section), a number-of-times-of-printing determining section 43 (equivalent to the printing determining section), a toner-image forming section 45, and a transfer-bias applying section 47. The functional blocks can be realized by the CPU 801 executing a computer program read out to the memory 803.

In the storing section 42, number-of-times-of-single-color-printing information is stored. The number-of-times-of-single-color-printing information is information concerning the number of times of printing performed when printing processing is executed in the single color (K) mode in the image forming apparatus (printing performed on one recording medium is counted as one printing processing). The number-of-times-of-single-color-printing information is updated by the CPU 801 every time printing processing on one sheet is executed.

In the storing section 42, number-of-times-of-printing reference information is stored. The number-of-times-of-printing reference information is information concerning a reference of the number of times of printing, which is a reference for determining possibility of execution of reverse transfer using the cleaning toner image explained later.

In the storing section 42, cleaning toner image information is stored. The cleaning toner image information is information concerning a toner image formed when the reverse transfer using the cleaning toner image explained later is executed. The cleaning toner image information includes, for example, information concerning a shape and a pattern of the cleaning toner image.

In the storing section 42, a transfer bias information is stored. The transfer bias information is information concerning bias applied to the transfer roller 9K when the reverse transfer using the cleaning toner image explained later is executed. The transfer bias information includes, for example, information concerning a voltage amount or a current amount applied when the cleaning toner image is reversely transferred.

Further, in the storing section 42, a record (a log) of executed printing processing is stored.

When printing in the single color (printing in the single color (K) mode) using the photoconductive drum 2K is executed, the number-of-times-of-printing-information acquiring section 41 acquires the number-of-times-of-single-color-printing information from the storing section 42 according to notification from the CPU 801 indicating the start of printing execution and indicating that printing is performed in the single color (K) mode. The number-of-times-of-printing-information acquiring section 41 sends the acquired number-of-times-of-single-color-printing information to the number-of-times-of-printing determining section 43.

The number-of-times-of-printing determining section 43 determines, using the number-of-times-of-single-color-printing information acquired by the number-of-times-of-printing-information acquiring section 41, whether the number of times of executed printing in the single color (K) exceeds the reference. Specifically, the number-of-times-of-printing determining section 43 acquires the number-of-times-of-printing reference information from the storing section 42 according to the acquisition of the number-of-times-of-single-color-printing information. The number-of-times-of-printing determining section 43 determines whether the number of times of printing executed using only the photoconductive drum 2K indicated by the number-of-times-of-single-color-printing information exceeds the reference indicated by the number-of-times-of-printing reference information.

If the number-of-times-of-printing determining section 43 determines that the number of times of printing executed using only the photoconductive drum 2K exceeds the reference, the number-of-times-of-printing determining section 43 gives an instruction to the toner-image forming section 45 and the transfer-bias applying section 47.

If the number-of-times-of-printing determining section 43 determines that the number of times of printing in the single color (K) executed using only the photoconductive drum 2K exceeds the reference, the toner-image forming section 45 forms toner images on the photoconductive drum 2Y and the photoconductive drum 2K. If the record (the log) stored in the storing section 42 indicates that a mode of executed image processing is the single color (K) mode, the toner-image forming section 45 acquires cleaning toner image information corresponding to the single color (K) mode. The toner-image forming section 45 executes the formation of the toner image using the cleaning image information corresponding to the single color (K) mode stored in the storing section 42.

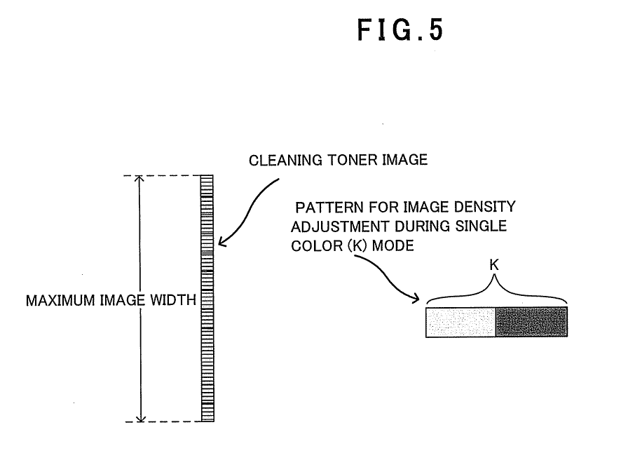

As a cleaning toner image, the toner-image forming section 45 forms, on the photoconductive drum 2Y, a toner image having length of a region in which a toner image in a rotation axis direction of the photoconductive drum 2K can be formed (hereinafter referred to as maximum image width). The toner-image forming section 45 forms a toner image of an image density adjustment pattern on the photoconductive drum 2K. The formed toner image is transferred onto the intermediate transfer belt 6 by the transfer roller 9K. The toner image is shown in FIG. 5. If the toner image is formed in a shape having the maximum image width, it is possible to further improve cleaning performance for the photoconductive drum.

The density (a toner deposit amount) of the toner image of the density adjustment pattern transferred onto the intermediate transfer belt 6 is detected by the toner density sensor 83 shown in FIG. 2 and density adjustment is performed. As shown in FIG. 5, the toner of the toner cartridge 1Y can be supplied to the photoconductive drum 2K using the cleaning toner image at the same timing as the image density adjustment by the single color (K) toner image.

The transfer-bias applying section 47 applies bias to the transfer roller 9Y and the transfer roller 9K and transfers the toner image shown in FIG. 5 from the photoconductive drums 1Y and 1K onto the intermediate transfer belt 6. The transfer-bias applying section 47 applies, while the cleaning toner image is in contact with the photoconductive drum 2K in a nip position between the photoconductive drum 2K and the intermediate transfer belt 6, bias to the transfer roller 9K and moves the toner from the toner image on the intermediate transfer belt 6 to the photoconductive drum 9K.

The transfer-bias applying section 47 applies transfer bias to the transfer roller 9K under a condition in which the toner of the cleaning toner image moves from the intermediate transfer belt 6 onto the photoconductive drum 2K more easily than the transfer of the toner image from the photoconductive drum 2K onto the intermediate transfer belt 6. Consequently, when the cleaning toner image passes the nip position between photoconductive drum 2K and the intermediate transfer belt 6, the toner easily moves from the intermediate transfer belt 6 onto the photoconductive drum 2K. The transfer-bias applying section 47 executes bias application control on the basis of transfer bias information.

Specifically, in the first embodiment, a current amount applied to the transfer roller 9K on the basis of control by the transfer-bias applying section 47 is larger than a current amount (e.g., +15 mA) applied to the transfer roller 9K when the toner image is transferred from the photoconductive drum 2K onto the intermediate transfer belt 6. Consequently, the toner on the intermediate transfer belt 6 changes to positive polarity with an excessive positive current. An amount of the toner moving from the cleaning toner image onto the photoconductive drum 2K can be increased on the basis of a relation between the potential of the photoconductive drum and the potential of the transfer roller.

In the first embodiment, the bias applied to the transfer roller 9K is subjected to constant current control on the basis of the control by the transfer-bias applying section 47.

The constant current control is a control system for keeping a transfer current flowing through the transfer roller constant. If the constant current control is used, it is possible to perform the reverse transfer while reducing influences by the environment such as temperature and humidity.

Further, the transfer-bias applying section 47 of the first embodiment applies bias suitable for reversely transferring the cleaning toner image also to the transfer rollers 9M and 9C that come into contact with the intermediate transfer belt 6 between the photoconductive drums 2K and 2Y. Consequently, the toner easily moves from the cleaning toner image onto the photoconductive drums 2M and 2C as well according to the reverse transfer. As a result, it is possible to improve cleaning performance in the photoconductive drums 2M and 2C as well.

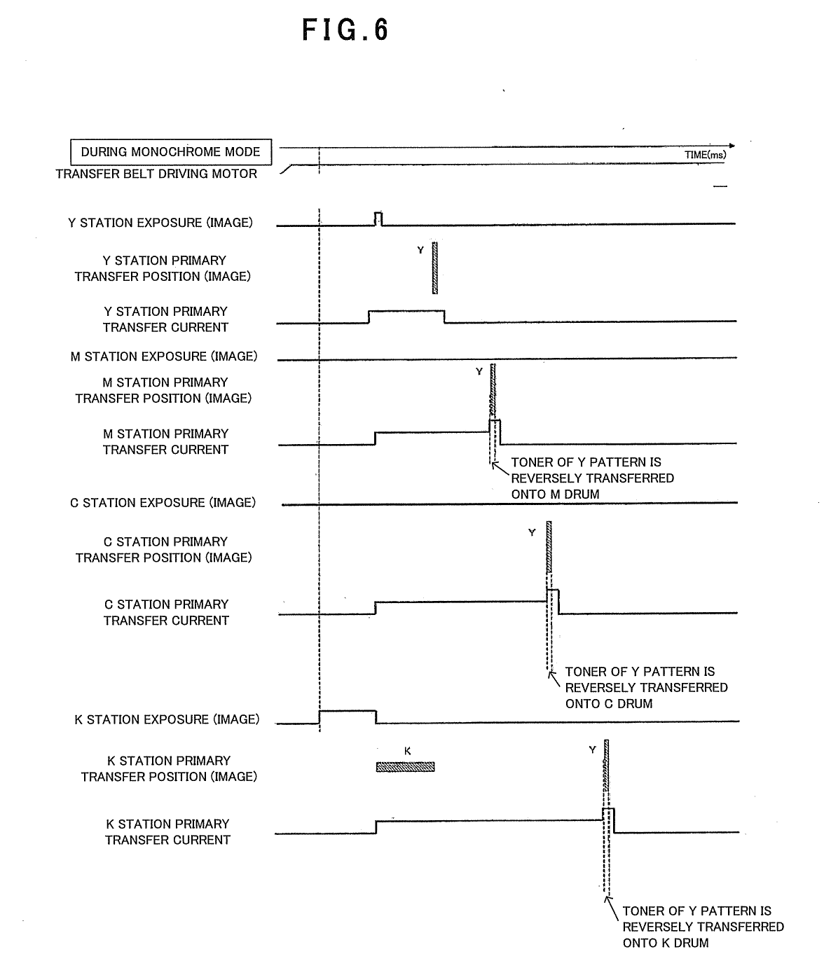

FIG. 6 is a diagram of an example of a timing chart concerning reverse transfer execution control for a toner during execution of monochrome mode in the first embodiment.

As shown in FIG. 6, first, the photoconductive drum 2K is exposed to light and an image density adjustment pattern of the single color (K) is formed by the developing unit 3K. Subsequently, a transfer bias is applied to the transfer rollers 9Y to 9K. A current amount in applying the bias is a current amount applied when the toners are normally transferred from the photoconductive drums 2Y to 2K onto the transfer belt 6 and image formation is executed (hereinafter referred to as normal transfer current amount). Consequently, the image density adjustment pattern of the single color (K) is transferred onto the intermediate transfer belt 6. Exposure is executed in the process unit 5Y (a Y station) and the toner is supplied from the developing unit 3Y, whereby the cleaning toner image is formed. The cleaning toner image is transferred from the photoconductive drum 2Y onto the intermediate transfer belt 6. The cleaning toner image moves from the nip position between the photoconductive drum 2Y and the intermediate transfer belt 6 to the secondary transfer position T. At this point, while the cleaning toner image is in contact with the photoconductive drums 2M, 2C, and 2K in the nip positions between the photoconductive drums 2M, 2C, and 2K and the intermediate transfer belt 6, the toners move from the cleaning toner image onto the photoconductive drums 2C to 2K, respectively (reverse transfer). As it is understood from FIG. 6, in the first embodiment, while the cleaning toner image passes the nip positions, a current amount applied as transfer bias is set larger than the normal transfer current amount (the current amount larger than the normal transfer current amount is hereinafter referred to as reverse transfer current amount). Those skilled in the art can appropriately set, taking into account driving speeds of the photoconductive drums and the intermediate transfer belt, a distance among the photoconductive drums, and the like, timing for switching the normal transfer current amount to the reverse transfer current amount and timing for ending application of bias at the reverse transfer current amount.

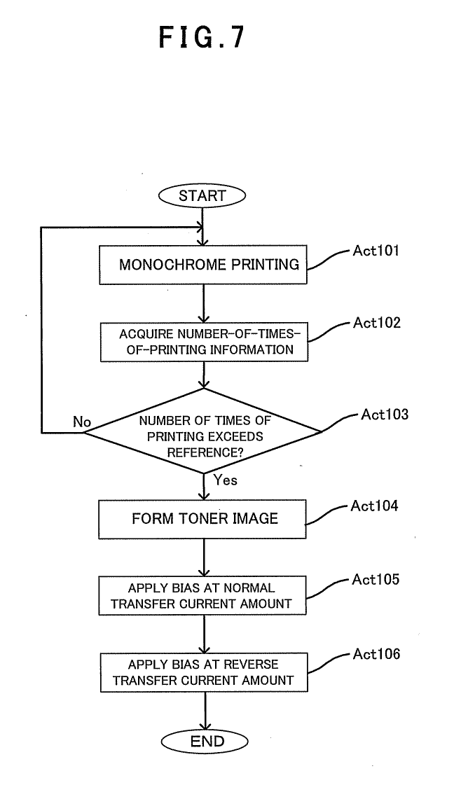

An example of a processing flow of the reverse transfer execution control for a toner during execution of the single color (K) mode in the image forming apparatus according to the first embodiment is explained with reference to FIG. 7.

First, in Act 101, the CPU 801 of the image forming apparatus executes printing processing in the single color (K) mode on the basis of a request from the user. In Act 102, the number-of-times-of-printing-information acquiring section 41 acquires the number-of-times-of-single-color-printing information from the storing section 42.

In Act 103, the number-of-times-of-printing determining section 43 determines, using the number-of-times-of-single-color-printing information, whether the number of times of printing in the single color (K) mode exceeds the reference. If the number-of-times-of-printing determining section 43 determines that the number of times of printing in the single color (K) mode does not exceed the reference, the CPU 801 returns to Act 101 and repeats the processing. On the other hand, if the number-of-times-of-printing determining section 43 determines that the number of times of printing in the single color (K) mode exceeds the reference, the CPU 801 proceeds to Act 104. The toner-image forming section 45 forms toner images to be transferred on the photoconductive drums 2Y and 2K. In Act 105, the transfer-bias applying section 47 transfers the toner images formed on the photoconductive drums 2Y and 2K onto the intermediate transfer belt 6 at the normal transfer current amount. The toner image formed on the photoconductive drum 2Y is the cleaning toner image and the toner image formed on the photoconductive drum 2K is the image density adjustment pattern of the single color (K). In Act 106, while the cleaning toner image passes the nip positions between the photoconductive drums 2M to 2K and the intermediate transfer belt 6, the transfer-bias applying section 47 applies bias to the transfer rollers 9M to 9K at the reverse transfer current amount.

If the circularity of the toner supplied to the photoconductive drum 2Y is set lower than the circularity of the toners supplied to the photoconductive drums 2M to 2K, it is possible to improve cleaning performance for the photoconductive drums without providing a new unit in the apparatus. On the other hand, for example, if printing in the single color (K) mode is continuously executed, the Y toner having the low circularity is hardly supplied according to the reverse transfer to the photoconductive drum 2K. Therefore, the toner is supplied to the photoconductive drum 2K only from the developing unit 3K. Therefore, in the past, if the printing in the single color (K) mode is continuously executed, cleaning performance for the photoconductive drum 2K is not improved.

According to the first embodiment, the number of times of printing in the single color (K) mode exceeds the reference, the cleaning toner image formed with the toner having the low circularity is formed and supplied to the nip position between the photoconductive drum 2K and the intermediate transfer belt 6. Therefore, the toner having the circularity lower than that of the toner supplied from the developing unit 3K moves onto the photoconductive drum 2K according to the reverse transfer. The toner having the low circularity is easily collected by the cleaning blade. Since the toner having the low circularity is also collected together, cleaning performance is improved. Therefore, for example, even if the printing in the single color (K) mode is continuously performed, it is possible to improve the cleaning performance for the photoconductive drum 2K.

### Second Embodiment

A second embodiment is explained below. Components same as those in the first embodiment are denoted by the same reference numerals and signs and explanation of the components is omitted (the same applies in embodiments explained later).

In the second embodiment, an image forming apparatus includes a separating mechanism configured to separate the photoconductive drums 2Y to 2C and the intermediate transfer belt 6 in a single color (K) mode. If printing is executed in the single color (K) mode, the photoconductive drum 2K on which a toner image is formed only has to be brought into contact with the intermediate transfer belt 6. The other photoconductive drums 2Y, 2M, and 2C that do not need to be operated are separated from the intermediate transfer belt 6 (contact is released). If a cleaning toner image is transferred onto the intermediate transfer belt 6, the photoconductive drums 2Y, 2M, and 2C are brought into contact with the intermediate transfer belt 6 (contact is restored). This makes it possible to reduce friction between photoconductive drums for yellow (Y), magenta (N), and cyan (C) and the intermediate transfer belt 6 and extend the life of the components.

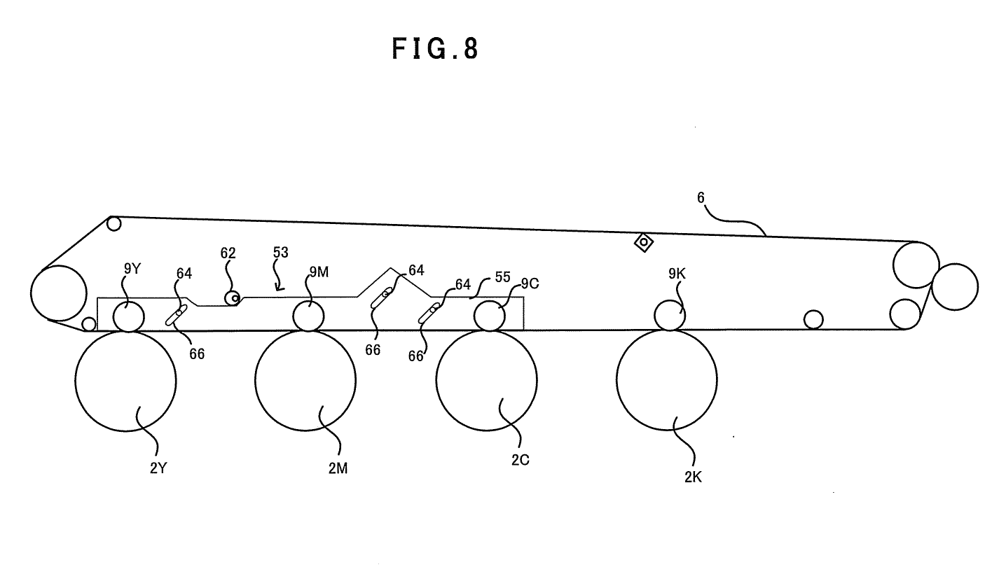

FIG. 8 is a schematic diagram of a switching mechanism at the time when the image forming apparatus according to the second embodiment executes image formation in a color mode.

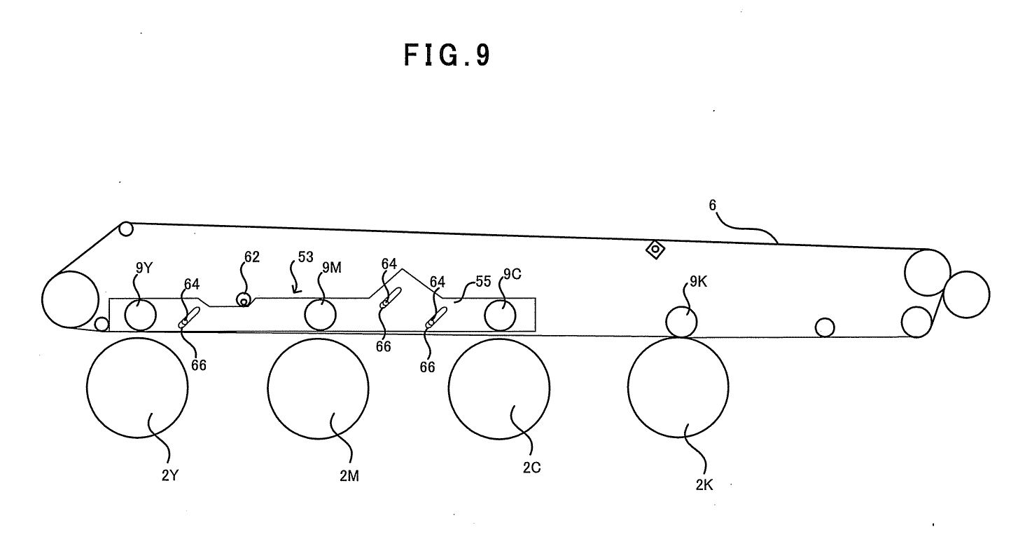

FIG. 9 is a schematic diagram of the switching mechanism at the time when the image forming apparatus according to the second embodiment executes image formation in the single color (K) mode.

The image forming apparatus according to the second embodiment includes the primary transfer rollers 9Y to 9C for yellow (Y), magenta (N), and cyan (C), a housing 55, an eccentric cam 62, and guide pins 64 and includes a separating unit 53 obtained by integrating the primary transfer rollers 9Y to 9C via the housing 55. The eccentric cam 62 is fit in a hollow in an upper part of the housing 55 of the separating unit 53. A not-shown driving motor is connected to the eccentric cam 62 of the separating unit 53. The eccentric cam 62 is rotated by the driving motor. The guide pins 64 are fixed and fit in long holes 66 provided in the housing 55.

If image formation is executed in the single color (K) mode, the eccentric cam 62 of the separating unit 53 is rotated by the motor. The eccentric cam 62 rotates and moves on the hollow of the housing 55, whereby the entire separating unit 53 moves upward along the long holes 66 in which the guide pins 64 are fit. Consequently, the photoconductive drums 2Y to 2C for yellow (Y), magenta (M), and cyan (C) and the intermediate transfer belt 6 separate from each other.

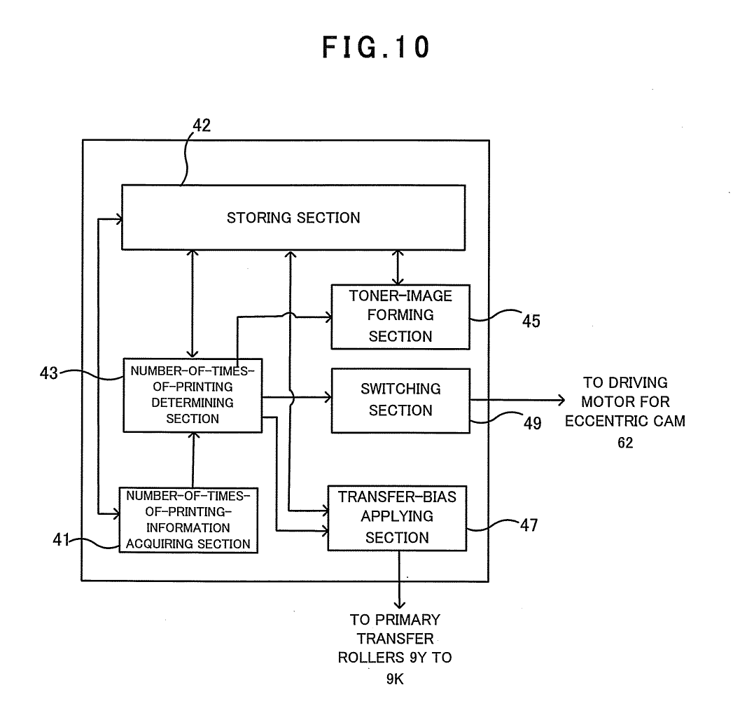

Functional blocks concerning reverse transfer execution control for a toner during execution of the single color (K) mode in the image forming apparatus according to the second embodiment are explained with reference to FIG. 10. The image forming apparatus according to the second embodiment includes a switching section 49 in addition to the components explained in the first embodiment.

If the number-of-times-of-printing determining section 43 determines that the number of times of printing in the single color (K) mode exceeds a predetermined number of times, the number-of-times-of-printing determining section 43 gives an instruction to the switching section 49 in addition to the toner-image forming section 45 and the transfer-bias applying section 47.

If formation of the cleaning toner image using the photoconductive drum 2Y is executed and the cleaning toner image is transferred onto the intermediate transfer belt 6, the switching section 49 controls the driving motor for the eccentric cam 62 on the basis of notification of a determination result from the number-of-times-of-printing determining section 43 and brings the photoconductive drums 2Y to 2C and the intermediate transfer belt 6, which are separated during the start of the execution of the single color (K) mode, into contact with each other.

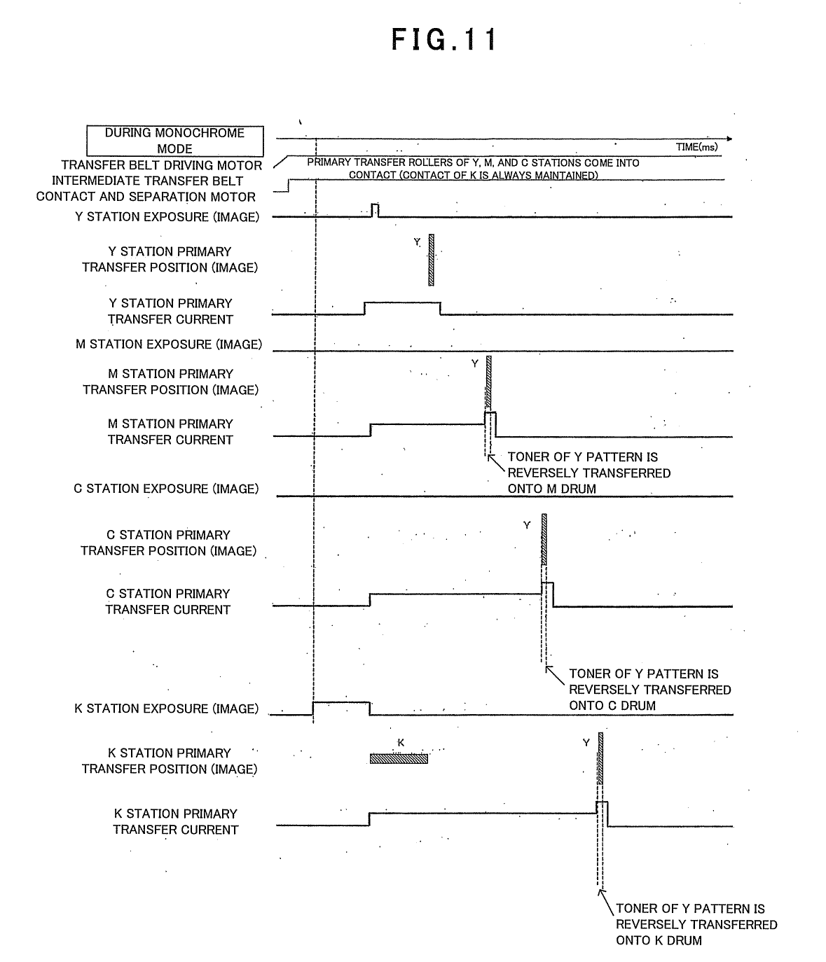

FIG. 11 is a diagram of an example of a timing chart concerning the reverse transfer execution control for a toner during the execution of the single color (K) mode in the second embodiment. Explanation same as the explanation in the first embodiment is omitted.

According to execution of printing in the single color (K) using the photoconductive drum 2K, the image forming apparatus controls the separating unit 53 and separates the photoconductive drums 2Y to 2C from the intermediate transfer belt 6. As it is understood from FIG. 11, in the second embodiment, prior to the formation of the cleaning toner image on the photoconductive drum 2Y and the transfer of the cleaning toner image onto the intermediate transfer belt 6, the image forming apparatus brings the photoconductive drums 2Y to 2C and the intermediate transfer belt 6 separated from each other into contact with each other.

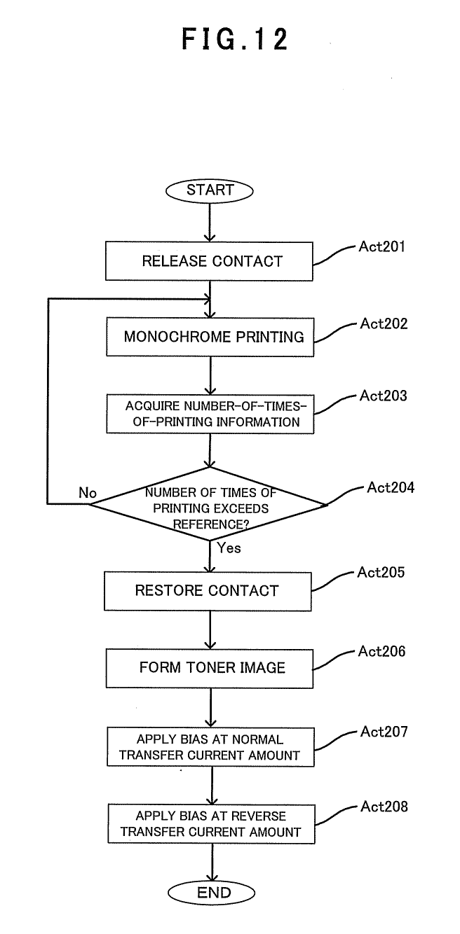

An example of a processing flow of the reverse transfer execution control for a toner during the execution of the single color (K) mode in the image forming apparatus according to the second embodiment is explained with reference to FIG. 12.

First, in Act 201, the CPU 801 of the image forming apparatus separates the photoconductive drums 2Y to 2C and the intermediate transfer belt 6 from each other on the basis of a printing processing execution request in the single color (K) mode from a user. Subsequently, in Act 202, the CPU 801 of the image forming apparatus executes printing processing in the single color (K) mode on the basis of a request from the user. In Act 203, the number-of-times-of-printing-information acquiring section 41 acquires number-of-times-of-single-color-printing information from the storing section 42.

In Act 204, the number-of-times-of-printing determining section 43 determines, using the number-of-times-of-single-color-printing information, whether the number of times of printing in the single color (K) mode exceeds a reference. If the number-of-times-of-printing determining section 43 determines that the number of times of printing in the single color (K) mode does not exceed the reference, the CPU 801 returns to Act 202 and repeats the processing. On the other hand, if the number-of-times-of-printing determining section 43 determines that the number of times of printing in the single color (K) mode exceeds the reference, the CPU 801 proceeds to Act 205 and brings the photoconductive drums 2Y to 2C and the intermediate transfer belt 6 into contact with each other. In Act 206, the toner-image forming section 45 forms toner images to be transferred on the photoconductive drums 2Y and 2K. In Act 207, the transfer-bias applying section 47 transfers the toner images formed on the photoconductive drums 2Y and 2K onto the intermediate transfer belt 6 at a normal transfer current amount. The toner image formed on the photoconductive drum 2Y is the cleaning toner image and the toner image formed on the photoconductive drum 2K is an image density adjustment pattern of the single color (K). In Act 208, while the cleaning toner image passes the nip positions between the photoconductive drums 2M to 2K and the intermediate transfer belt 6, the transfer-bias applying section 47 applies bias to the transfer rollers 9M to 9K at a reverse transfer current amount.

### Third Embodiment

In a third embodiment, an image forming apparatus forms a cleaning toner image according to the number of times of printing even if image formation is executed in a color mode in addition to a single color (K) mode. The cleaning toner image corresponding to the color mode can also be used in combination with an image density adjustment pattern.

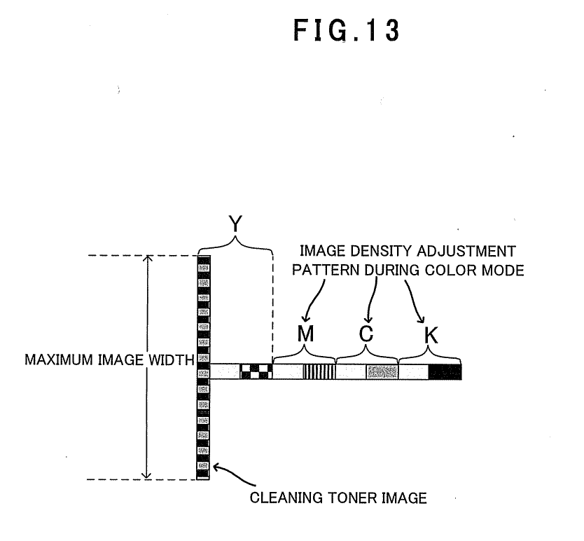

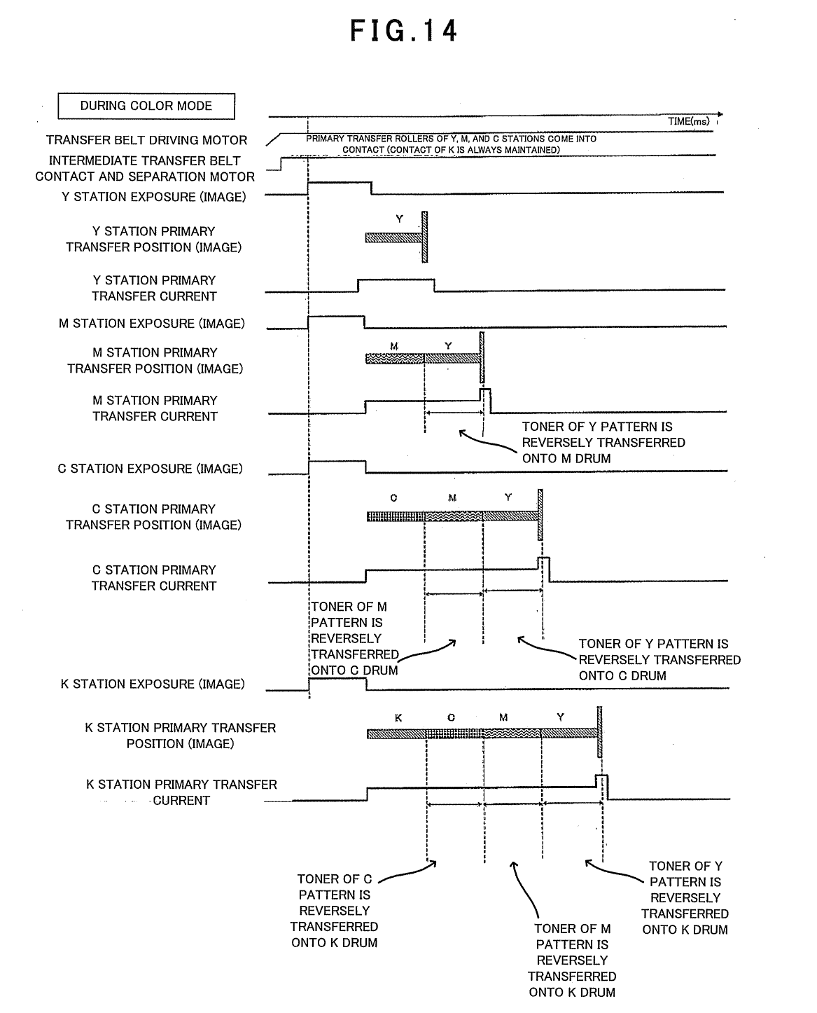

A toner image formed in the third embodiment is shown in FIG. 13. An example of a timing chart concerning reverse transfer execution control for a toner during execution of the color mode is shown in FIG. 14.

In the storing section 42, number-of-times-of-color-printing information is stored. The number-of-times-of-color-printing information is information concerning the number of times printing is executed in the color mode.

The number-of-times-of-printing-information acquiring section 41 acquires the number-of-times-of-single-color-printing single-information from the storing section 42 according to notification from the CPU 801 indicating the start of printing execution and indicating that printing is performed in the color mode.

The number-of-times-of-printing determining section 43 determines, using the number-of-times-of-color-printing information acquired by the number-of-times-of-printing-information acquiring section 41, whether the number of times of executed printing in the color mode exceeds a reference. Specifically, the number-of-times-of-printing determining section 43 acquires number-of-times-of-printing reference information from the storing section 42 according to the acquisition of the number-of-times-of-color-printing information. The number-of-times-of-printing determining section 43 determines whether the number of times of printing executed using only the photoconductive drums 2Y to 2K indicated by the number-of-times-of-color-printing information exceeds the reference indicated by the number-of-times-of-printing reference information.

If the number-of-times-of-printing determining section 43 determines that the number of times of printing executed using the photoconductive drums 2Y to 2K exceeds the reference, the toner-image forming section 45 forms toner images on the photoconductive drums 2Y to 2K and causes the transfer-bias applying section 47 to execute transfer of the toner images from the photoconductive drums 2Y to 2K onto the intermediate transfer belt 6. The toner-image forming section 45 acquires, on the basis of a record (a log) of printing processing stored in the storing section 42, toner image information (a pattern of a cleaning toner image C and an image density adjustment pattern) corresponding to the color mode stored in the storing section 42. Specifically, if the record (the log) stored in the storing section 42 indicates that a mode of executed image processing is the color mode, the toner-image forming section 45 acquires toner image information corresponding to the color mode. The toner-image forming section 45 forms the cleaning toner image using the toner image information corresponding to the color mode.

### Other Embodiments

The first to third embodiments are explained above. However, the present invention is not limited to these embodiments. Other embodiments are also possible.

For example, in the first to third embodiments, the circularity of the toner supplied to the photoconductive drum 2Y is lower than the circularity of the toners supplied to the photoconductive drums 2M to 2K. However, the present invention is not limited to this form. For example, a toner supplied to one photoconductive drum used for image formation in a single color and a toner supplied to a photoconductive drum that is in contact with an intermediate transfer belt further upstream than the photoconductive drum used for the image formation in the single color and is used for transfer of a cleaning toner image only have to have different circularities.

It is also possible to adopt a form in which a toner supplied to one photoconductive drum used for image formation in a single color and a toner supplied to a photoconductive drum that is in contact with an intermediate transfer belt further upstream than the photoconductive drum used for the image formation in the single color and is used for transfer of a cleaning toner image have different particle diameters. For example, it is possible to adopt a form in which the particle diameter of the toner supplied to the photoconductive drum 2Y used for formation of the cleaning toner image is larger than the particle diameter of the toner supplied to the photoconductive drum 2K used during execution of image formation in a single color (K) mode.

The particle diameter can be represented by, for example, a volume average particle diameter. The volume average particle diameter means a particle diameter (a volume D 50) of particles that is calculated from a volume sum of respective particles calculated from the particle diameters and corresponds to a volume sum of 50%. The volume average particle diameter can be measured using, for example, Multisizer 3 (Beckman Coulter, Inc.: aperture diameter 100 μm). A value of the volume average particle diameter is obtained by measuring particle diameters concerning, for example 50,000 particles.

It is also possible to adopt a form in which a toner supplied to one photoconductive drum used for image formation in a single color and a toner supplied to a photoconductive drum that is in contact with an intermediate transfer belt further upstream than the photoconductive drum used for the image formation in the single color and is used for transfer of a cleaning toner image have different circularities and different particle diameters.

In the first to third embodiments, the photoconductive drum 2Y is used for cleaning toner image formation. However, the present invention is not limited to this. Other forms can be adopted. For example, the photoconductive drums 2M to 2C may be used for the cleaning toner image formation. On the other hand, since yellow is a color hardly distinguishable in detail by naked eyes, a high-quality image can be formed by using the photoconductive drum 2Y for the cleaning toner image formation.

In the second embodiment, the photoconductive drums 2Y to 2C are integrally separated from or brought into contact with the intermediate transfer belt. However, the present invention is not limited to this. For example, it is also possible to adopt a form in which, during the cleaning toner image formation, the photoconductive drum 2Y is brought into contact with the intermediate transfer belt while the photoconductive drums 2M and 2C are kept separated from the intermediate transfer belt.

In the first to third embodiments, when the toner is moved from the cleaning toner image onto the photoconductive drum, transfer bias having polarity same as the polarity of transfer bias for transferring the toner image from the photoconductive drum onto the intermediate transfer belt is applied to the transfer roller. As another form, when the toner is moved from the cleaning toner image on the intermediate transfer belt onto the photoconductive drum, bias having polarity opposite to the polarity of bias for transferring the toner image from the photoconductive drum onto the intermediate transfer belt may be applied to the transfer roller.

The number-of-times-of-single-color-printing information according to the first to third embodiments is an example of the single color printing information. Possibility of formation of the cleaning toner image may be determined on the basis of other information concerning printing in a single color. For example, the possibility of formation of the cleaning toner image may be determined on the basis of a toner used amount per one or plural printing jobs calculated on the basis of a printing ratio.

Further, in the first to third embodiments, the toner images are transferred from the photoconductive drums 2Y to 2K onto the recording medium such as a sheet via the intermediate transfer belt 6. However, the present invention is not limited to this form. For example, it is also possible to adopt a form in which the toner images are transferred, not via the intermediate transfer belt, from the photoconductive drums 2Y, 2M, 2C, and 2K arranged to be opposed to a conveying member such as a belt onto a sheet conveyed by the belt.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and method described herein may be made without departing from the spirit of the inventions. The accompanying claims and their equivalents are intended to cover such forms or modifications as would fall within the scope and spirit of the inventions.

As explained above in detail, according to the technique described in this specification, it is possible to suppress an increase in size of an apparatus and improve cleaning performance for an image bearing member.

What is claimed is:

1. An image forming apparatus comprising:
a first image bearing member on which a toner is supplied to a formed electrostatic latent image and a toner image is formed;
a cleaning member configured to come into contact with the first image bearing member and remove the toner remaining on the first image bearing member after the toner image is transferred;
a second image bearing member on which a toner having at least a particle diameter or a circularity different from that of the toner supplied to the first image bearing member is supplied to a formed electrostatic latent image and a toner image is formed, the second image bearing member coming into contact with, further upstream than a contact position between the first image bearing member and a conveyed recording medium or a transfer member configured to transfer the toner image onto the recording medium, the recording medium or the transfer member;
a first transfer member configured to be applied with bias and transfer the toner image formed on the first image bearing member onto the recording medium or the transfer member;
a second transfer member configured to be applied with bias and transfer the toner image formed on the second image bearing member onto the recording medium or the transfer member;
a printing-information acquiring section configured to acquire, if printing in a single color using the first image bearing member is executed, single color printing information, which is information concerning the printing in the single color;
a printing determining section configured to determine, using the single color printing information acquired by the printing-information acquiring section, whether the executed printing in the single color exceeds a reference;
a toner-image forming section configured to form the toner image on the second image bearing member if the printing determining section determines that the executed printing in the single color exceeds the reference; and
a transfer-bias applying section configured to apply the bias to the first transfer member and the second transfer member, transfer the toner image formed on the second image bearing member by the toner-image forming section onto the recording medium or the transfer member, and move the toner from the toner image on the recording medium or the transfer member onto the first image bearing member.

2. The apparatus according to claim 1, wherein the transfer-bias applying section applies, while the toner image on the recording medium or the transfer member is in contact with the first image bearing member, bias to the first transfer member under a condition in which the toner moves from the toner image onto the first image bearing member more easily than the transfer of the toner image from the first image bearing member onto the recording medium or the transfer medium.

3. The apparatus according to claim 1, wherein the toner-image forming section forms, on the second image bearing member which is rotatable, the toner image having length of a region in which a toner image in a rotation axis direction of the first image bearing member which is rotatable be formed.

4. The apparatus according to claim 1, separating the second image bearing member and the recording medium or the transfer member from each other if the printing in the single color using the first image bearing member is executed and
further comprising a switching section configured to bring the second image bearing member and the recording medium or the transfer member separated from each other into contact with each other if formation of the toner image using the second image bearing member is executed according to control by the toner-image forming section.

5. The apparatus according to claim 1, further comprising:
plural image bearing members configured to come into contact with the recording medium or the transfer member between the first image bearing member and the second image bearing member; and
plural transfer members configured to be applied with bias and transfer toner images formed on the plural image bearing members onto the recording medium or the transfer member, wherein
the transfer-bias applying section applies bias to the plural transfer members and moves toners from the toner image on the recording medium or the transfer member onto the plural image bearing members while the toner image transferred from the second image bearing member are in contact with the plural image bearing members.

6. The apparatus according to claim 1, wherein the transfer-bias applying section applies bias to the first transfer member at a current amount larger than a current amount applied when a toner image is transferred from the first image bearing member onto the recording medium or the transfer member and moves the toner from the toner image on the recording medium or the transfer member onto the first image bearing member.

7. The apparatus according to claim 1, wherein the transfer-bias applying section applies bias to the first transfer member at polarity opposite to polarity of bias for transferring a toner image from the first image bearing member onto the recording medium or the intermediate transfer member and moves the toner from the toner image on the recording medium or the transfer member onto the first image bearing member.

8. The apparatus according to claim 1, wherein a particle diameter of the toner supplied to the second image bearing member is larger than a particle diameter of the toner supplied to the first image bearing member.

9. The apparatus according to claim 1, wherein a circularity of the toner supplied to the second image bearing member is lower than a circularity of the toner supplied to the first image bearing member.

10. The apparatus according to claim 1, wherein the single color printing information is information concerning a number of times of printing in the single color using the first image bearing member.

11. A cleaning method for an image bearing member in an image forming apparatus transferring a toner image formed on a first image bearing member onto a recording medium or a transfer member by a first transfer member configured to be applied with bias, removing the toner remaining on the first image bearing member by a cleaning member configured to come into contact with the first image bearing member after the toner image is transferred, and transferring a toner image with a toner having at least a particle diameter or a circularity different from that of the toner supplied to the first image bearing member, formed on a second image bearing member, at a position which is upstream than a contact position between the first image bearing member and the recording medium or the transfer member, onto the recording medium or the transfer member, by a second transfer member configured to be applied with bias, the cleaning method comprising:
acquiring, if printing in a single color using the first image bearing member is executed, single color printing information, which is information concerning the printing in the single color;
determining, using the acquired single color printing information, whether the executed printing in the single color exceeds a reference;
forming the toner image on the second image bearing member if it is determined that the executed printing in the single color exceeds the reference; and
applying the bias to the first transfer member and the second transfer member, transferring the toner image formed on the second image bearing member onto the recording medium or the transfer member, and moving the toner from the toner image on the recording medium or the transfer member onto the first image bearing member.

12. The method according to claim 11, further comprising applying, while the toner image on the recording medium or the transfer member is in contact with the first image bearing member, bias to the first transfer member under a condition in which the toner moves from the toner image onto the first image bearing member more easily than the transfer of the toner image from the first image bearing member onto the recording medium or the transfer member.

13. The method according to claim 11, wherein
the method further comprising forming, on the second image bearing member which is rotatable, the toner image having length of a region in which a toner image in a rotation axis direction of the first image bearing member which is rotatable be formed.

14. The method according to claim 11, further comprising separating the second image bearing member and the recording medium or the transfer member from each other if the printing in the single color using the first image bearing member is executed and bringing the second image bearing member and the recording medium or the transfer member separated from each other into contact with each other if formation of the toner image using the second image bearing member is executed.

15. The method according to claim 11, further comprises:
transferring toner images formed on plural image bearing members which come into contact with the recording medium or the transfer member between the first image bearing member and the second image bearing member onto the recording medium or the transfer member by plural transfer members configured to be applied with bias, and
applying bias to the plural transfer members and moving toners from the toner image on the recording medium or the transfer member onto the plural image bearing members while the toner image transferred from the second image bearing member are in contact with the plural image bearing members.

16. The method according to claim 11, further comprising applying bias to the first transfer member at a current amount larger than a current amount applied when a toner image is transferred from the first image bearing member onto the recording medium or the transfer member and moving the toner from the toner image on the recording medium or the transfer member onto the first image bearing member.

17. The method according to claim 11, further comprising applying bias to the first transfer member at polarity opposite to polarity of bias for transferring a toner image from the first image bearing member onto the recording medium or the intermediate transfer member and moving the toner from the toner image on the recording medium or the transfer member onto the first image bearing member.

18. The method according to claim 11, wherein a particle diameter of the toner supplied to the second image bearing member is larger than a particle diameter of the toner supplied to the first image bearing member.

19. The method according to claim 11, wherein a circularity of the toner supplied to the second image bearing member is lower than a circularity of the toner supplied to the first image bearing member.

20. The method according to claim 11, wherein the single color printing information is information concerning a number of times of printing in the single color using the first image bearing member.
